(19) United States
(12) Patent Application Publication
(10) Pub. No.: US 2009/0079280 A1
(43) Pub. Date: Mar. 26, 2009

(54) Motor Apparatus

(76) Inventors: Takahiro Terauchi, Kiryu-shi (JP); Chikafumi Sugai, Kiryu-shi (JP); Takeshi Yamazaki, Kiryu-shi (JP); Satoru Negishi, Kiryu-shi (JP); Hideaki Fujii, Kiryu-shi (JP)

Correspondence Address: KENYON & KENYON LLP, ONE BROADWAY, NEW YORK, NY, 10004, US

(21) Appl. No.: 11/918,033

(22) PCT Filed: Apr. 7, 2006
(86) PCT No.: PCT/JP2006/307439

§ 371 Date: Oct. 5, 2007

(30) Foreign Application Priority Data
Apr. 8, 2005 (JP) 2005111543

(51) Int. Cl. H02K 5/22; H02K 11/00

(52) U.S. Cl. 310/71; 310/68 B

(57) ABSTRACT

A motor apparatus 1 has a brushless motor 2 and a control unit 3 that is directly connected to a bracket 14 of the brushless motor 2. An attaching section 20 is formed on the bracket 14. A power-supply connection port 27 and a connection port for sending a signal output from a sensor are provided to protrude on the attaching section 20. A slit 46 for receiving the connection ports 27 into the casing 41 is formed on the control unit 3. The connection port 27 having been inserted into the casing 41 is welded to bus bars 50 and 51 of the circuit substrate 43.

### TECHNICAL FIELD

The present invention relates to a motor apparatus for driving motor rotation by supplying electric power from a control unit.

### PRIORITY CLAIM

The present application claims priority to patent application No. 2005-111543 filed Apr. 8, 2005, in Japan, the content of which is incorporated herein by reference.

### BACKGROUND ART

A motor, e.g., a brushless motor is configured to rotate a rotor while detecting the position of the rotor by a position-detecting sensor and switching electric current to a coil of a stator unit based on an output signal sent by a position-detecting sensor. The electric current sent to the brushless motor 2 is controlled by a control unit that is configured separately from the brushless motor. A port extending from a control unit is inserted into a brushless motor and fixed therein in some conventional motor apparatuses so that a power supply line between the brushless motor and the control unit or a signal line for the position-detecting sensor would not be needed (see, for example, Patent Document 1).

The motor apparatus has an opening section on a side of the housing of the brushless motor. When the control unit is attached to a peripheral section of the opening section, a power supply port extending from the control unit enters the housing via the opening section. The power supply port extends to overlap a terminal having a coil connected thereto. Screw holes formed on the terminal and holes formed on the terminal coincide in position. Therefore, inserting the screws from a front surface of the housing and screwing the screws outwardly by means of a driver engage the terminal with the port, thereby fixing the control unit to the brushless motor.

Patent Document 1: Japanese Unexamined Patent Application, First Publication No.

### DISCLOSURE OF INVENTION

### Problems to be solved by the Invention

However a circuit substrate was susceptible to significant stress during assembling the conventional structure for attaching the brushless motor to the control unit since a power supply port fixed to a circuit substrate provided in the control unit is fixed to the brushless motor after being inserted into a bracket. Countermeasures to prevent foreign body intrusion during transportation etc. needed to be conceived since the brushless motor has an opening section for accommodating a power supply port.

The present invention was made in view of the aforementioned circumstances, and the principal object is to attach a control unit to a motor by an easy operation, i.e., reliably and without affecting the performance of the motor and the control unit.

### Means for Solving the Problems

In order to solve the above problems, a motor apparatus according to a first aspect of the present invention is characterized in including: a motor; and a control unit for controlling the driving of the motor so that the motor and the control unit can be assembled separately, a power-supply connection port and a connection port for a signal output by a position-detecting sensor of a rotor of the motor protrude from a lateral section of the motor, and the connection ports are configured to be able to be connected to the control unit.

The motor apparatus provides electric connection between the motor and the control unit that are assembled separately by inserting connection ports previously protruding toward the motor into the control unit while excluding electric wiring, etc.

A second invention associated with the first aspect of the present invention is characterized in that a first connector including the connection ports is provided on the motor to protrude therefrom; and a second connector capable of being connected to the first connector and including a joint connection port that is electrically connected to the connection ports is provided to the control unit.

In the motor apparatus, the connection ports previously protruding from the motor are connected to the joint connection port of the control unit by engaging the pair of connectors. No significant stress will act on the circuit substrate connected to the motor via the joint connection port since the joint connection port is fixed to the control unit via connectors.

A third invention associated with the first aspect of the present invention is the motor apparatus that is characterized in that a slit, into which the connection ports can be inserted, is provided on a casing of the control unit, and a metal-made port that can be connected to the connection port inserted into the casing is disposed on a circuit substrate fixed to the casing.

The motor apparatus achieves electric connection between the motor and the control unit by inserting the connection ports previously protruding from the motor into the casing of the control unit and by engaging the connection ports with a metal port fixed to a circuit substrate in the casing.

Also, the bracket of the motor may be connected to the control unit via a connection port unit having the connection ports disposed therein. A position-detecting sensor for the rotor may be provided to this case of the connection port unit.

### EFFECTS OF THE INVENTION

The stress acting onto the circuit substrate of the control unit can be reduced significantly in the present invention since the control unit can be attached to the motor previously having the connection port attached thereto. Foreign body intrusion into the motor can be prevented since the connection ports protrude from the motor; and since motor assembly will not be completed until an opening section communicating with the inside of the motor remains. Therefore, transportation and assembly of motors can be facilitated.

### BRIEF DESCRIPTION OF DRAWINGS

FIG. 1 is a schematic view showing the configuration of motor apparatus according to an embodiment of the present invention.

FIG. 2 shows the configuration of the brushless motor of FIG. 1 in cross-section.

FIG. 3 is a view along arrow A in FIG. 2.

FIG. 4 shows a non-capped configuration of FIG. 2.

FIG. 5 shows the configuration of a connection port unit in plan view of the motor apparatus shown in FIG. 1.

FIG. 6 is a view of the control unit along arrow B shown in FIG. 1.

FIG. 7 shows the structure for attaching the motor apparatus to a control unit in enlarged cross-sectional view according to a second embodiment of the present invention.

FIG. 8 shows the configuration in cross-sectional view in the vicinity of a rotor and a bracket in the motor apparatus according to a third embodiment of the present invention.

FIG. 9 is a view along arrow C in FIG. 8.

FIG. 10 is a side view showing the configuration of a connection port unit shown in FIG. 8.

FIG. 11 is a view along arrow D in FIG. 10.

### EXPLANATION OF REFERENCE NUMERALS AND SYMBOLS

1: motor apparatus
2: brushless motor (motor)
3: control unit
14: bracket
27: power-supply connection terminal (power-supply connection port)
29, 30: Hall ICs (position-detecting sensor)
31: output connection port (connection port for sending an output signal)
32: connection port unit
41: casing
43: circuit substrate
45, 46: slits
50, 51: bus bars (metal-made ports)
61: socket (first connector)
65: plug (second connector)
68: joint connection port

### BEST MODE FOR CARRYING OUT THE INVENTION

Preferable embodiments for carrying out the present invention are explained in details with reference to drawings as follows.

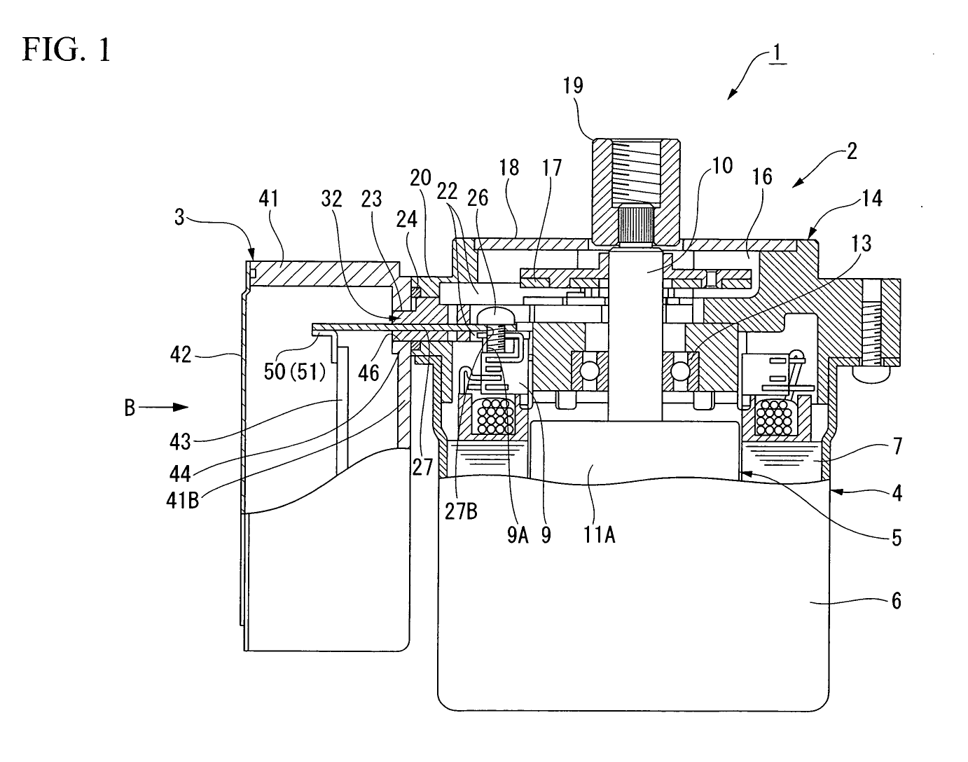

As illustrated in FIG. 1, a control unit 3 for controlling the rotation of a brushless motor 2 is attached directly onto the brushless motor 2 in a motor apparatus 1.

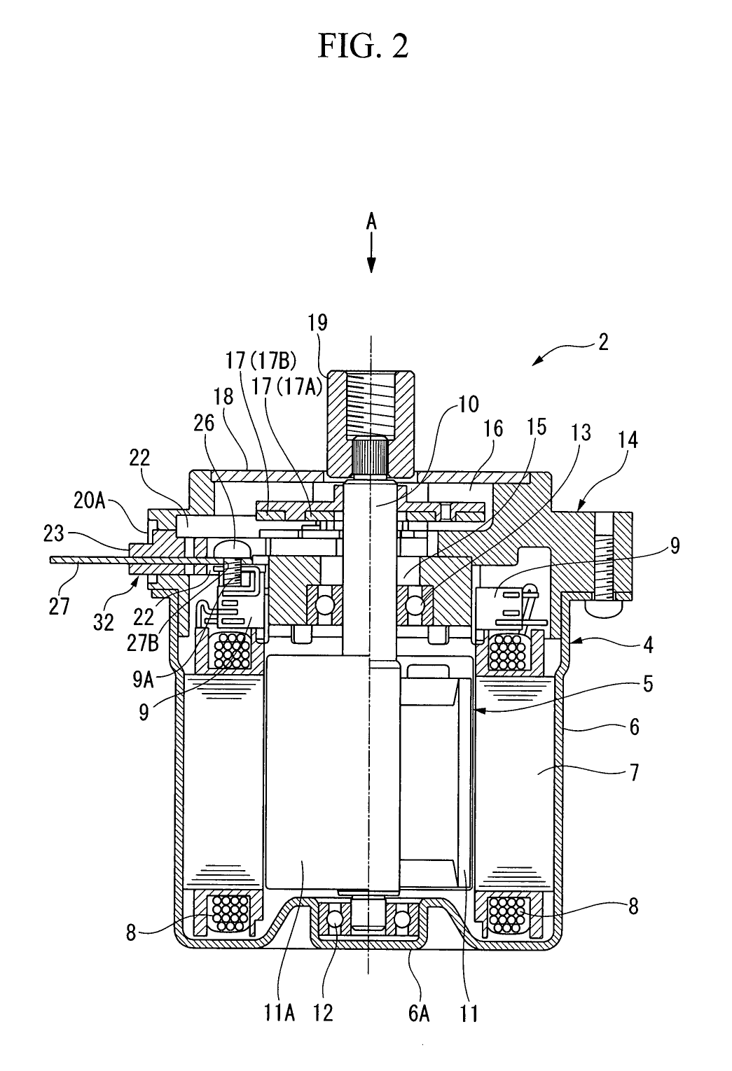

As illustrated in FIGS. 1 and 2, the brushless motor 2 is of an inner rotor type having a rotor 5 in a stator unit 4. The stator unit 4 has a motor casing 6 which is cylindrical in shape having a bottom. A circular stator core 7 is press-fit into the motor casing 6. The stator core 7 is produced by accumulating a plurality of metal-made core plates in an axial direction of the brushless motor 2. A coil 8 is formed by winding a plurality of wires around teeth each extending at a constant interval on an inner periphery of the stator core 7. The coil 8 is connected to a terminal 9 fixed in the opening section of the motor casing 6.

The rotor 5 has a rotation shaft 10. A permanent magnet 11 having a plurality of magnet poles disposed in a circumferential direction is fixed on an outer periphery section of the rotation shaft 10. A magnet cover 11A is attached to cover the exterior thereof. An end section of the rotation shaft 10 is rotatively supported by a bearing 12 press-fit into the bottom section 6A of a motor casing 6. The other end section of the rotation shaft 10 is rotatively supported by a bearing 13. The bearing 13 is press-fit into a bracket 14 covering the opening section of the motor casing 6.

The bracket 14 is fixed to the motor casing 6 by screws. A support hole 15 in to which the bearing 13 is press-fit is disposed in the center of the bracket 14. A housing section 16 having a diameter greater than that of the support hole 15 is disposed above the support hole 15. A magnet 17 fixed to the rotor 5 is rotatively enclosed in the housing section 16. The magnet 17 for use here has several magnetic poles magnetically adhering with each other in a circumferential direction. An opening at the other end of the housing section 16 is sealed by a ring-shaped cap 18. A coupler 19 which is connected to another apparatus is attached to the rotation shaft 10 of the rotor 5 that protrudes from the cap 18.

As illustrated in FIGS. 1 to 4, the bracket 14 is formed by bulging a part of the circular outer periphery section covering the opening section of the motor casing 6. An attaching section 20 having a plane attaching surface 20A is formed on the bracket 14. Two screw holes 21 are formed on the attaching surface 20A of the attaching section 20. A joint section 23 is fixed between the screw holes 21. As illustrated in FIG. 1, a seal member 24 is inserted into a recessed portion formed between the outer periphery section of the joint section 23 and the attaching section 20.

Three power-supply connection ports 27 (connection ports for supplying electric power) and seven output connection ports 31 (connection ports for outputting a signal) are provided to protrude outwardly in a radial direction. A notched recessed portion 27A is formed on each tip section of each of the protruding power-supply connection ports 27. The power-supply connection ports 27 protrude into a communication hole 22 formed on the bracket 14. The power-supply connection port 27 retracted into the bracket 14 causes the motor casing 6 to communicate with the housing section 16. A hole 27B is formed on a base end section of the power-supply connection port 27 exposed through the communication hole 22. As illustrated in FIG. 1, each power-supply connection port 27 is electrically connected to each terminal 9 corresponding to three-phase coil 8 in the stator unit 4 by using the hole 27B and a screw hole 9A of the terminal 9.

Also, the output connection port 31 retracted into the housing section 16 of the bracket 14 is electrically connected to output ports of Hall ICs (Integrated Circuits) 29 and 30 disposed on a sensor substrate 28 fixed onto the bracket 14 by screws 25 in the housing section 16. The Hall ICs 29 and 30 are disposed to face the permanent magnet 11 that rotates with the rotor 5. The Hall ICs 29 and 30 are position-detecting sensors for the rotor 5 that are configured to switch outputs when the magnet poles of the magnet 17 in the proximity of the Hall ICs 29 and 30 change in accordance with the rotation of the rotor 5. Three Hall ICs 29 are disposed corresponding to an inner periphery magnet 17A having a fewer magnet poles in the inner circumference of the magnet 17. The Hall IC 30 is disposed corresponding to an outer periphery magnet 17B having more magnet poles on the outer circumference of the magnet 17.

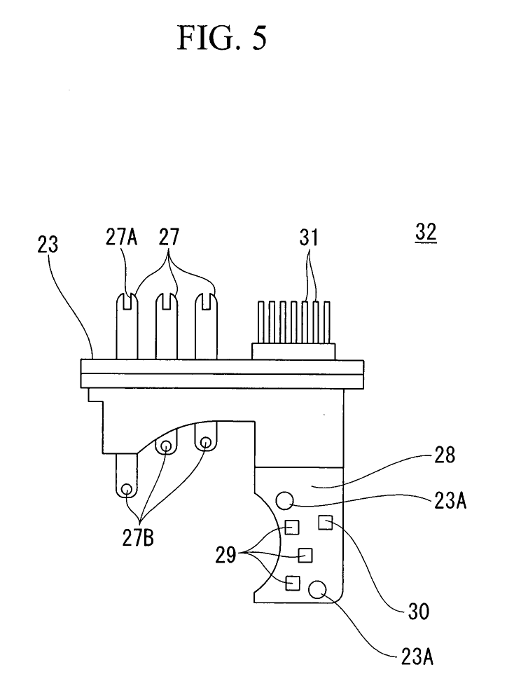

Also, in the present embodiment, wirings, which are not shown in the drawing, for electrically connecting the Hall ICs 29 and 30 to the power-supply connection port 27, the sensor substrate 28, and an output connection port 31 are supported by a resin part forming the joint section 23. These components as a whole constitute a connection port unit 32 as shown in FIG. 5. It should be noted that a reference numeral 23A indicates a screw hole through which the screw 25 penetrates. The screw hole 23A penetrates the joint section 23 and the sensor substrate 28.

As illustrated in FIG. 1, the control unit 3 has a space defined by a rectangle-shaped casing 41 and a lid 42 fixed to close an opening section 41A of the casing 41. A circuit substrate 43 is fixed in the space. A receiving section 44 having a receiving plane is disposed at a bottom section 41B that faces the opening section 41A. Elongated slits 45 and 46 are formed at the receiving section 44. The slits 45 and 46 are of a size so that the connection ports 27 and 31 can enter the casing 41. Holes for inserting screws 47 therethrough are formed on the receiving section 44. The slits 45 and 46 are located between the holes. These holes are formed corresponding to screw holes 21 on the attaching section 20. These holes are used for fixing the control unit 3 to the brushless motor 2. Power devices and circuits implemented on the circuit substrate 43 are configured to calculate the timing to switch the electric power supplied to each phase of the coil 8 in the stator unit 4 based on the output signal sent from the Hall ICs 29 and 30 and supplying the electric power to each phase based on the calculation result. It should be noted that a connector which is not shown in the drawing is disposed at the casing 41. The connector can be connected to the power supply through a cable.

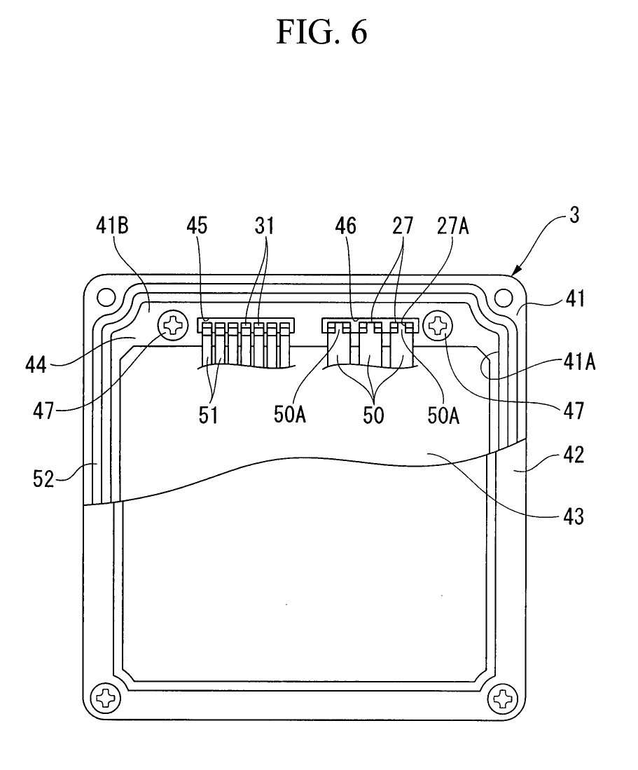

A bus bar 50 having three metal ports and a bus bar 51 having seven metal ports extend from the circuit substrate 43 that are suitably located in accordance with the connection ports 27 and 31. As illustrated in FIG. 1, the end section of each of the bus bars 50 and 51 is bent in the extending directions of the connection ports 27 and 31 so that an area where the bus bars 50 and 51 make contact with the connection ports 27 and 31 is significant. Furthermore, as illustrated in FIG. 6, a protruding section 50A is formed at each end section of the bus bar 50. The protruding section 50A fits with the recessed portion 27A of the power-supply connection port 27. It should be noted that the bus bars 50 and 51 should be fixed respectively to the connection ports 27 and 31 by using welding method, etc.

Operations in the present embodiment are explained as follows.

Assembling the motor apparatus 1 consists of assembling the stator unit 4 and assembling the rotor 5 separately. The stator unit 4 is assembled by press-fitting the bearing 12 and the stator core 7 having the coil 8 wound around thereof into the motor casing 6, and by fixing the terminal 9 having the wire of the coil 8 attached thereto to the motor casing 6. The rotor 5 is assembled by attaching a magnet cover 11A onto the rotation shaft 10 having the permanent magnet 11 fixed thereto and by pivotally supporting the other end of the rotation shaft 10 by the bearing 13 that is press-fit into the bracket 14.

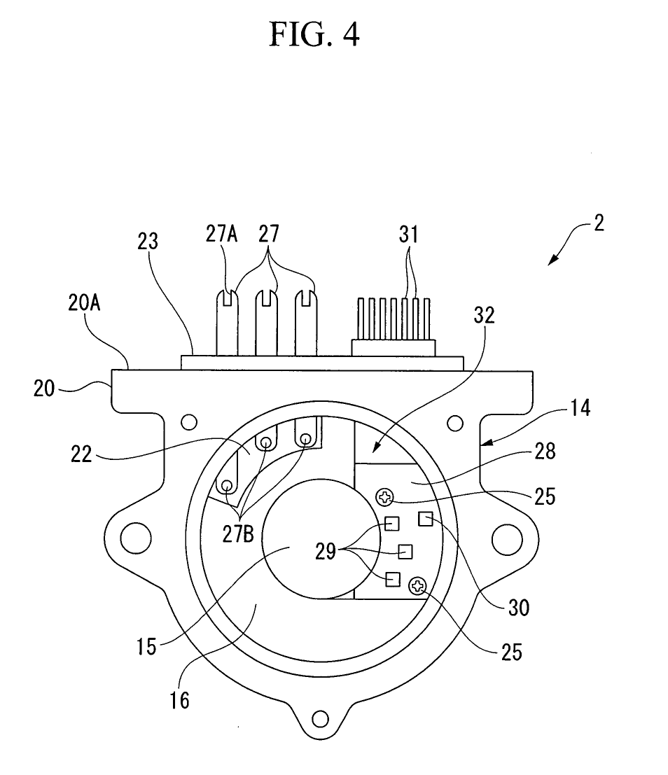

Herein prior to the step for inserting the rotation shaft 10 of the rotor 5 into the bracket 14, the connection port unit 32 is inserted into the bracket 14 through the attaching surface 20A and the communication hole 22 so that the base end section of the power-supply connection port 27 and the sensor substrate 28 are disposed toward the bracket 14. A hole 27B of the base end section is exposed through the communication hole 22, and the sensor substrate 28 is disposed at a predetermined position in the housing section 16. Consequently, as illustrated in FIG. 4, the sensor substrate 28 is fixed to the bracket 14 by tightening the screws 25 into the screw holes 23A in the housing section 16. Furthermore inserting the rotation shaft 10 of the rotor 5 into the bracket 14, conforming the holes 27B of the power-supply connection port 27 to the corresponding screw holes 9A in position, and tightening the screws 26 thereinto cause the power-supply connection port 27 to be connected to the terminal 9. Furthermore, the magnet 17 is fixed to the other end section of the rotation shaft 10 in the housing section 16 beneath the bracket 14. This enables detecting of the change in magnetic pole by means of Hall ICs 29 and 30.

The rotor 5 is inserted into the stator unit 4 after separately assembling the stator unit 4 and the rotor 5. The rotation shaft 10 of the rotor 5 is pivotally supported by the bearing 12 and then, the bracket 14 is screw-fit to the motor casing 6 by using screws. Consequently the coupler 19 is attached to the rotation shaft 10 after closing the housing section 16 with the cap 18. In addition, the seal member 24 is inserted into the attaching section 20 so as to cover the outer periphery section of the joint section 23. This completes the assembling of the brushless motor 2.

The control unit 3 and the brushless motor 2 can be assembled separately. The control unit is assembled by producing the circuit substrate 43 by implementing circuits and the bus bars 50 and 51 on a substrate and fixing the produced circuit substrate 43 onto the casing 41.

The control unit 3 is attached to the brushless motor 2 by bringing the control unit 3 close to the attaching section 20 of the brushless motor 2 and entering the connection ports 27 and 31 that protrude from the attaching surface 20A into the casing 41 through the slits 45 and 46 of the casing 41. Further, since contacting made by the attaching surface 20A onto a plane surface of the receiving section 44 breaks the seal member 24 thus, a liquid-tight structure is obtained between the bracket 14 and the casing 41. Tightening the screws 47 into this state of the opening sections 41A of the casing 41 locates the casing 41 on the bracket 14 at a fixed position. Since this state of the recessed portion 27A of the power-supply connection port 27 engages with the protruding section 50A of the bus bar 50, and the output connection port 31 makes contact with the bus bar 51, the connection ports 27 and 31 are fixed to the corresponding bus bars 50 and 51 by using a welding method.

Consequently inserting a seal member 52 into the casing 41 and further screw-fitting the lid 42 thereonto block the opening section 41A of the casing 41. This completes the assembling of the motor apparatus 1. That is, the brushless motor 2 is connected to the control unit 3 via the connection port unit 32 in the motor apparatus 1.

When the rotor 5 of the brushless motor 2 rotates in the motor apparatus 1, the Hall ICs 29 and 30 detect the position of the rotor 5 based on the change in the magnetic poles of the magnet 17. The output signal based on the detection is put into a circuit implemented on the circuit substrate 43 through the output connection port 31 and the bus bar 51. The circuit substrate 43 calculates the timing of switching the electric power based on the signal output by the Hall ICs 29 and 30 and supplies electric power to the coil 8 having the corresponding phase based on the calculated timing from a specific bus bar 50 through the power-supply connection port 27 and the terminal 9. This results in causing the rotor 5 to be rotated by a magnetic circuit formed by the stator core 7 and the rotor 5.

The present embodiment prevents a significant force from being applied to the circuit substrate 43 of the control unit 3 during assembling the motor apparatus 1 since the brushless motor 2 is produced by previously fixing the power-supply connection port 27 and the output connection port 31 onto the bracket 14 and since the connection ports 27 and 31 are fixed to the control unit 3. Also the reliability of the connecting section can be enhanced since the recessed portion 27A of the power-supply connection port 2 is engaged with the protruding section 50A of the bus bar 50. Also foreign body intrusion into the brushless motor 2 can be prevented in transportation conducted during the assembly since the brushless motor 2 can be assembled independently without providing an opening section separately by previously fixing the connection port unit 32 having connection ports 27 and 31 to the bracket 14. Therefore, since transportation or subsequent operation can be facilitated thus, the efficiency in the operation can be enhanced.

Although the slits 45 and 46 for receiving the connection ports 27 and 31 are formed on the control unit 3, the control unit 3 is less susceptible to foreign body intrusion than the brushless motor 2 since the control unit 3 is assembled in a place invulnerable to foreign body intrusion such as a dust-free room, e.g., a clean room in view of the configuration including the circuit substrate 43. Therefore the slits 45 and 46 formed on the control unit 3 do not affect the assembling operation of the motor apparatus 1 or the performance of the motor apparatus 1.

Next, a second embodiment of the present invention will be explained with reference to drawings. It should be noted that the present embodiment is different from the first embodiment because a brushless motor is configured to be attached to a control unit differently. Note that elements that are equivalent to those of the above embodiment will be assigned the same reference symbols and redundant explanations thereof will be omitted.

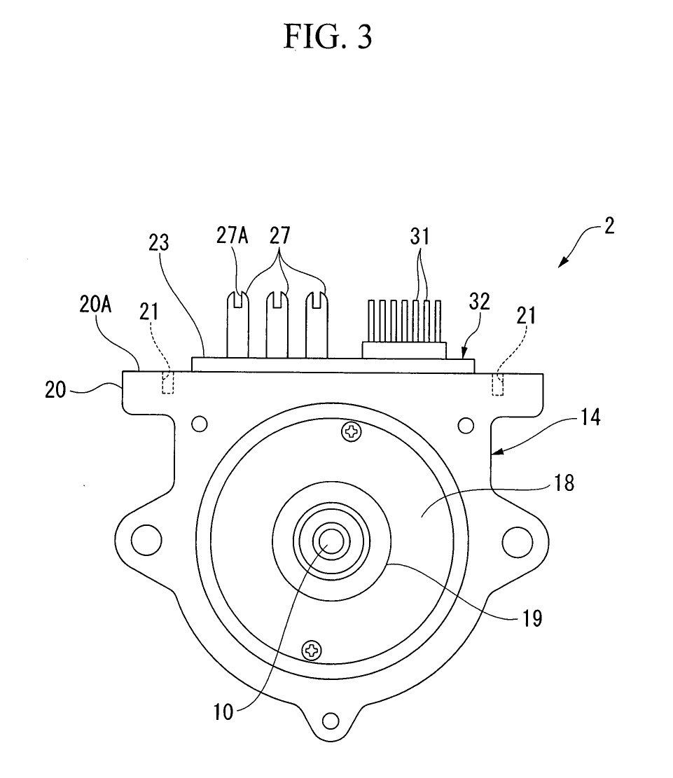

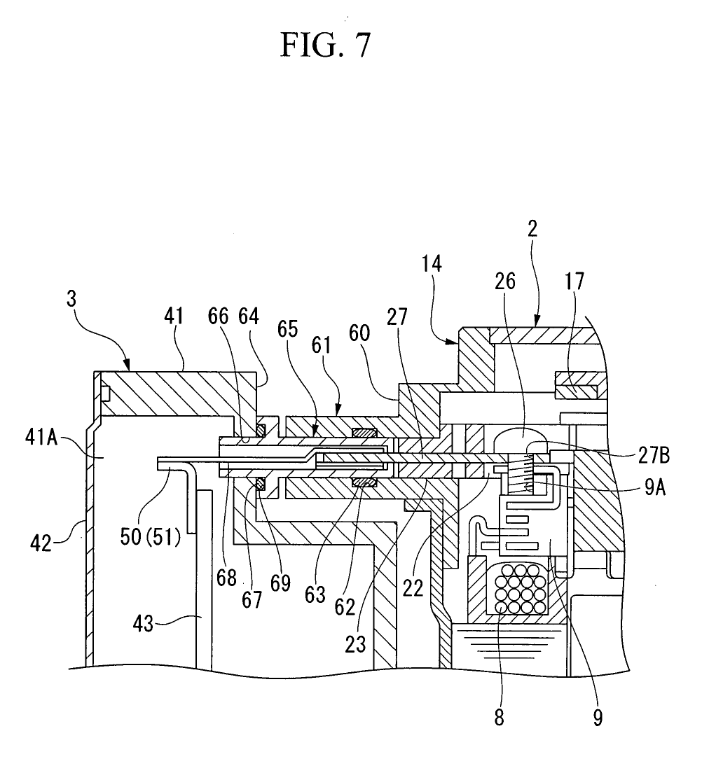

As illustrated in FIG. 7, an attaching section 60 is provided on an outer periphery section of the bracket 14. The power-supply connection port 27 and the output connection port 31 (see, for example, FIG. 3), not shown in FIG. 7, are provided to protrude from the attaching section 60 radially outwardly so that the power-supply connection port 27 is in parallel with the output connection port 31. Furthermore, a first connector socket 61, formed unitarily with the bracket 14, for covering the connection ports 27 and 31 is formed outwardly in a radial direction on the attaching section 60. The socket 61 is longer than each protruding part of the connection ports 27 and 31. Also, a groove 62 is formed on an inner circumferential part of the socket 61 into which a seal member 63 is inserted.

The control unit 3 is configured to accommodate the circuit substrate 43 in the space defined by the casing 41 and the lid 42. A recessed portion 64 is formed on an end section facing the bracket 14 in the casing 41. A second connector plug 65 is fixed to the plug 65. The plug 65 has an outer shape capable of being inserted into the socket 61. Furthermore, the base end section of the plug 65 enters the casing 41 through a slit 66 formed on the recessed portion 64 of the casing 41. A seal member 67 disposed between the plug 65 and the casing 41 provides a liquid-tight structure. In addition, a plurality of metal-made joint connection ports 68 are disposed in the plug 65. Each base end section of the joint connection port 68 retracted into the casing 41 is welded to the bus bars 50 and 51 each provided on the circuit substrate 43. A tip end section protruding from the casing 41 in each joint connection port 68 has a boxed shape so as to be capable of receiving and engaging with the connection ports 27 and 31 of the brushless motor 2.

The seal member 63 is inserted into the groove 62 of the socket 61 to assemble the brushless motor 2. In addition, the power-supply connection port 27 and the output connection port 31 are connected to the terminal 9 and the Hall ICs 29 and 30 respectively. Assembling the control unit 3 is accompanied with: inserting the joint connection port 68 into the plug 65 to fix therein; inserting the seal member 67 into a groove 69 formed on the base end of the plug 65; inserting the base end section of the plug 65 into the slit 66; and fixing the base end section of the plug 65 to the casing 41 by using screws which are not shown in the drawings. A liquid-tight structure is formed by breaking this state of the seal member 67. Furthermore, since the joint connection port 68 is fixed to each of the bus bars 50 and 51 by using a welding method thus, the opening section 41A of the casing 41 is closed by the lid 42 since each joint connection port 68 makes contact to each of the bus bars 50 and 51 disposed correspondingly.

The plug 65 is inserted into the socket 61 to attach the control unit 3 to the brushless motor 2. The joint connection port 68 engages with the corresponding power-supply connection port 27 and the output connection port 31 for electric connection. The plug 65 engages with the socket 61 by means of the seal member 63 thus, a liquid-tight structure is formed. This causes the control unit 3 to be attached to the brushless motor 2.

The present embodiment facilitates positioning and assembling of the control unit 3 and the brushless motor 2 since the control unit 3 is connected to the brushless motor 2 by means of the socket 61 and the plug 65. Also significant stress acting onto the circuit substrate 43 can be prevented during the assembling operation since the joint connection port 68 is fixed in the plug 65 fixed in the casing 41. Other effects are the same as those explained with respect to the first embodiment.

Next, a third embodiment of the present invention will be explained with reference to drawings. It should be noted that the present embodiment is different from the first embodiment because the shape of the connection port unit 32 for connecting a brushless motor to a control unit is different from that used in the first embodiment. Note that elements that are equivalent to those of the above embodiment will be assigned the same reference symbols and redundant explanations thereof will be omitted.

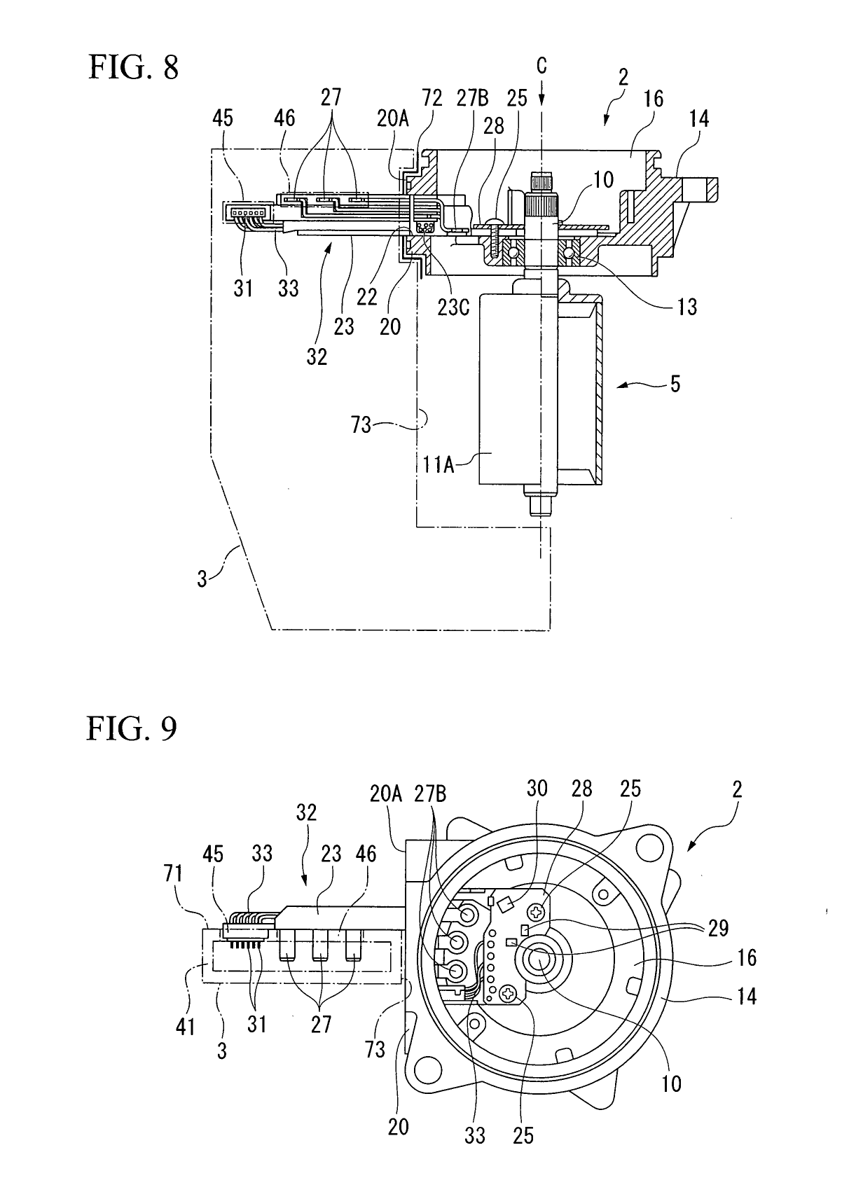

As illustrated in FIGS. 8 and 9, similarly to the first embodiment, the connection port unit 32 is inserted into the housing section 16 through the attaching surface 20A and the communication hole 22 so that a base end section of the power-supply connection port 27 and the sensor substrate 28 are disposed toward the bracket 14. The sensor substrate 28 is fixed to the bracket 14 in the housing section 16 by the screws 25 threaded into the screw holes 23A.

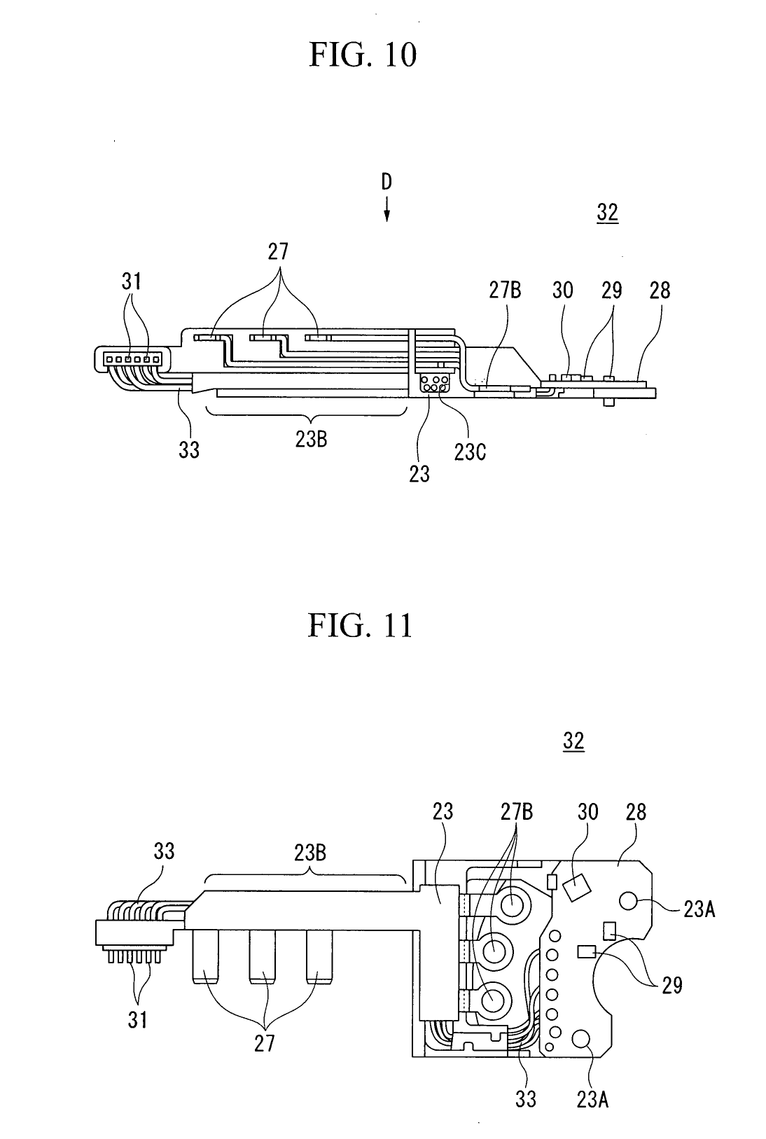

Furthermore, in the present embodiment, a section forming a tip end section (indicated by reference symbol 23B in FIGS. 10 and 11) of the connection port unit 32 of the joint section 23 protrudes from the attaching surface 20A outwardly in a radial direction relative to the rotor 5. In addition, a tip end section of the power-supply connection port 27 and a tip end section of the output connection port 31 protrude laterally (in a direction orthogonal to the axis of the rotor 5) from a lateral surface along the axial direction of the rotor 5. Also, reference numeral 33 indicates wiring for electrically connecting the output connection port 31 to the Hall ICs 29 and 30. The wiring is disposed in the groove section 23C formed on the joint section 23.

A circuit substrate, not shown in the drawing, is provided in the control unit 3. The elongated slits 45 and 46 are formed on a side surface 71 of the control unit 3 facing the power-supply connection port 27 and the output connection port 31. The slits 45 and 46 are of size so that the connection ports 27 and 31 can enter the casing 41 of the control unit 3. The control unit 3 and the brushless motor 2 can be assembled separately. Also, reference numeral 72 indicates a sealing material disposed between the attaching surface 20A and a side surface 73 facing the brushless motor 2 of the control unit 3.

The stator unit 4 and the rotor 5 are assembled separately to assemble the motor apparatus 1. Furthermore, prior to the step of inserting the rotation shaft 10 of the rotor 5 into the bracket 14, the connection port unit 32 is inserted into the bracket 14 through the attaching surface 20A and the communication hole 22 so that the base end section of the power-supply connection port 27 and the sensor substrate 28 are disposed toward the bracket 14. The hole 27B of the base end section and the sensor substrate 28 are disposed at predetermined positions in the housing section 16. Consequently the rotation shaft 10 of the rotor 5 is inserted into the bracket 14 after fixing the sensor substrate 28 to the bracket 14 by screws 25. The holes 27B of the power-supply connection port 27 are conformed to screw holes of a terminal which is not shown in the drawings. The power-supply connection port 27 is connected to the terminal by tightening screws thereinto not shown in the drawings. Furthermore, a magnet, not shown in the drawings, is fixed to the other end section of the rotation shaft 10 in the housing section 16 beneath the bracket 14.

The control unit 3 is attached to the brushless motor 2 by disposing the side surface 71 of the control unit 3 to face the power-supply connection port 27 and the output connection port 31. The connection ports 27 and 31 are inserted into the casing 41 through the slits 45 and 46 of the casing 41. Further, since contacting made by the attaching surface 20A onto a plane surface of the receiving section 73 breaks the seal member 72 thus, a liquid-tight structure is obtained between the bracket 14 and the casing 41 by means of the seal member 72 disposed between the attaching surface 20A and the side surface 73 that makes contact with the attaching surface 20A. This state of the casing 41 and the bracket 14 is positioned and fixed by using screws that are not shown in the drawings. That is, the brushless motor 2 is connected to the control unit 3 via the connection port unit 32 in the motor apparatus 1. Other operations and effects are the same as those explained with respect to the first embodiment.

It should be noted that the present invention is not limited to the above embodiment, i.e., the present invention can be applied to various aspects.

For example, a welding method, fitting method, or electric connection may be used for the power-supply connection port 27 fixed to the terminal 9 by using screws in the previous embodiments. Furthermore, the power-supply connection port 27 may be engaged with the wiring of the coil 8 directly. Also, a configuration may be employed in which a slit is formed on a wall section of the casing 41; the bus bars 50 and 51 are disposed substantially to be flush with an inner surface of the slit; and the connection ports 27 and 31 are engaged by the casing 41. Simultaneously, the configuration may be capable of electrically connecting the connection ports 27 and 31 to the bus bars 50 and 51.

The seal members 24, 52, 63, and 72 may be an O-ring or a liquid gasket, etc. The first connector may be a plug and the second connector may be a socket.

Also, the motor apparatus 1 is not limited to the brushless motor 2. The motor apparatus 1 can be used for other kinds of motors and for structures for attaching the motor to the control unit 3 for controlling thereof.

### INDUSTRIAL APPLICABILITY

The present invention allows the motor to be attached to a control unit reliably in a simple operation without affecting performance.

1-5. (canceled)

6. A motor apparatus comprising:
a motor; and
a control unit for controlling the driving of the motor, wherein
the motor and the control unit can be assembled separately,
a power-supply connection port and a connection port for a signal output by a position-detecting sensor of a rotor of the motor protrude from a lateral section of the motor, and
the connection ports are configured to be able to be connected to the control unit.

7. The motor apparatus according to claim 6, wherein
a first connector including the connection ports is provided on the motor to protrude therefrom, and
a second connector capable of being connected to the first connector and including a joint connection port that is electrically connected to the connection port is provided to the control unit.

8. The motor apparatus according to claim 6, wherein a slit, into which the connection ports can be inserted, is provided on a casing of the control unit, and a metal-made port that can be connected to the connection port inserted into the casing is disposed on a circuit substrate fixed to the casing.

9. The motor apparatus according to claim 6, wherein the bracket of the motor is connected to the control unit via a connection port unit having the connection ports disposed therein.

10. The motor apparatus according to claim 7, wherein the bracket of the motor is connected to the control unit via a connection port unit having the connection ports disposed therein.

11. The motor apparatus according to claim 8, wherein the bracket of the motor is connected to the control unit via a connection port unit having the connection ports disposed therein.

12. The motor apparatus according to claim 9, wherein a position-detecting sensor for detecting the position of the rotor is disposed in the connection port unit.

13. The motor apparatus according to claim 10, wherein a position-detecting sensor for detecting the position of the rotor is disposed in the connection port unit.

14. The motor apparatus according to claim 11, wherein a position-detecting sensor for detecting the position of the rotor is disposed in the connection port unit.
